(19) United States
(12) Patent Application Publication
(10) Pub. No.: US 2025/0189756 A1
(43) Pub. Date: Jun. 12, 2025

(54) CONTROL APPARATUS, LENS APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: YUTA MATSUURA, Tochigi (JP)

(21) Appl. No.: 18/952,392

(22) Filed: Nov. 19, 2024

(30) Foreign Application Priority Data
Dec. 11, 2023 (JP) 2023-208376

(51) Int. Cl. G02B 7/10; G02B 7/28

(52) U.S. Cl. CPC G02B 7/102; G02B 7/282

(57) ABSTRACT

A control apparatus for reducing focus fluctuation of a zoom lens including a focus lens and a magnification varying lens includes a processor configured to acquire, at a first time, information on a position of the magnification varying lens for a second time after the first time and information on an object distance for the second time, acquire a first target position according to the position of the magnification varying lens at the second time and the object distance at the second time, using control information on the position of a magnification varying lens and a position of the focus lens according to the object distance, and control driving of the focus lens using control information and the first target position.

### BACKGROUND

### Technical Field

The present disclosure relates to lens control that performs autofocus (AF) and zoom tracking.

### Description of Related Art

A zoom lens that controls the driving of a focus lens using AF often performs zoom tracking that controls the driving of the focus lens in order to reduce focus fluctuations associated with zooming. In this case, the focus lens may be driven by AF during zoom tracking.

Japanese Patent No. 6071669 discloses a method of normalizing position information of the focus lens so as to properly operate servo AF that tracks a focus of a moving object, even when the servo AF is performed during zooming.

In a case where the focus lens is driven by AF during zoom tracking, the control deviation of the focus lens may increase. For example, in a case where the focus lens is driven by AF while zoom tracking is performed during continuous zooming, the focus lens is likely to accelerate or decelerate suddenly as soon as AF starts. In a case where sudden acceleration or deceleration occurs, a delay occurs in the control of the drive speed of the focus lens, and the control deviation increases. As the control deviation increases, a still image that is out of focus or a moving image that is out of focus for a long time may be captured. In particular, in a case where the drive direction of the focus lens in zoom tracking and the drive direction of the focus lens in AF during zoom tracking are opposite to each other, reverse drive occurs, in which the drive direction of the focus lens suddenly switches. Reverse drive is likely to increase the control deviation.

### SUMMARY

A control apparatus according to one aspect of the disclosure for reducing focus fluctuation of a zoom lens including a focus lens and a magnification varying lens includes a processor configured to acquire, at a first time, information on a position of the magnification varying lens for a second time after the first time and information on an object distance for the second time, acquire a first target position according to the position of the magnification varying lens at the second time and the object distance at the second time, using control information on the position of a magnification varying lens and a position of the focus lens according to the object distance, and control driving of the focus lens using control information and the first target position. A lens apparatus and an image pickup apparatus each having the above control apparatus also constitute another aspect of the disclosure. A control method corresponding to the above control apparatus, and a storage medium storing a program that causes a computer to execute the above control method also constitute another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates a configuration of a lens interchangeable type camera system according to a first embodiment.

FIG. 2 illustrates electronic cam information.

FIGS. 3A and 3B explain a method of calculating a focus position.

FIG. 4 is a flowchart illustrating lens control processing according to the first embodiment.

FIG. 5 illustrates a focus drive locus in the first embodiment.

FIG. 6 is a flowchart illustrating lens control processing according to a second embodiment.

FIG. 7 illustrates focus drive in the second embodiment in a case where a focus drive direction by zoom tracking and a focus drive direction by AF are different from each other.

FIG. 8 illustrates focus drive in the second embodiment in a case where the focus drive direction by zoom tracking and the focus drive direction by AF are the same directions.

FIG. 9 is a flowchart illustrating lens control processing according to a third embodiment.

FIG. 10 illustrates focus drive in the third embodiment in a case where a focus drive direction by zoom tracking and a focus drive direction by AF are different from each other.

FIG. 11 illustrates focus drive according to the third embodiment in a case where the focus drive direction by zoom tracking and the focus drive direction by AF are the same directions.

FIG. 12 explains reverse drive of the focus lens by AF during zoom tracking.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

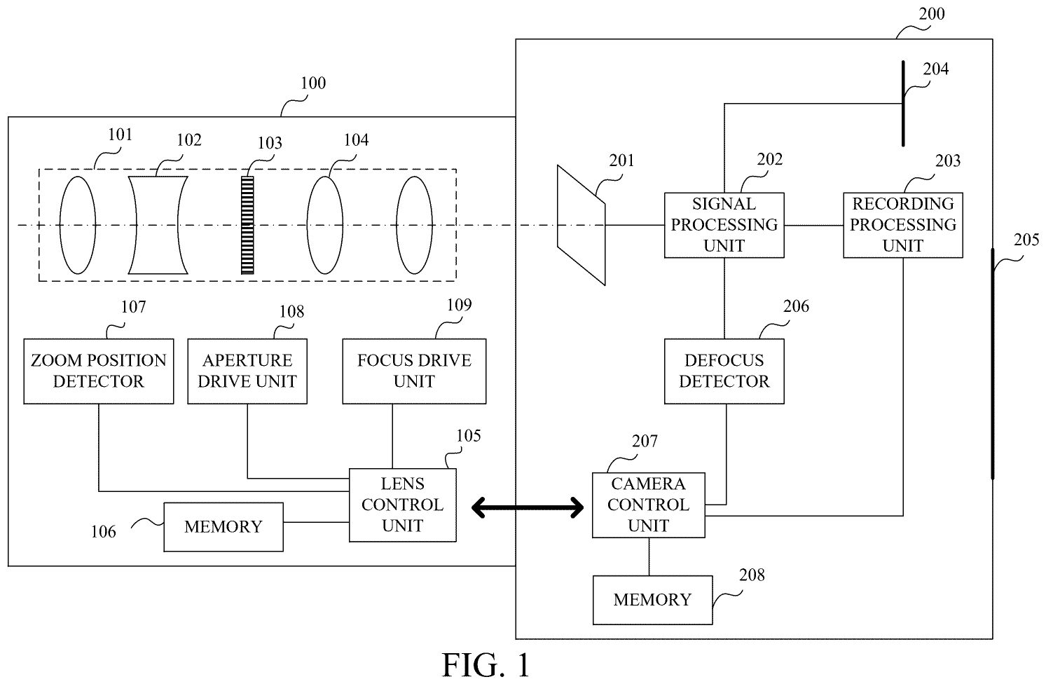

FIG. 1 illustrates a configuration of a lens interchangeable type camera system according to this embodiment. The lens interchangeable type camera system includes a lens apparatus 100, and a camera body 200 as an image pickup apparatus to which the lens apparatus 100 is detachably attached, and can capture still and moving images.

The lens apparatus 100 includes a zoom lens 101 as an imaging optical system configured to form an object image on an image sensor 201 in the camera body 200, and a lens control unit 105 communicable with a camera control unit 207 in the camera body 200.

The zoom lens 101 includes a magnification varying lens (zoom lens) 102, an aperture stop (diaphragm) 103, and a focus lens 104. The magnification varying lens 102 can move in the optical axis direction according to a user operation of an unillustrated zoom operation ring. The focal length of the zoom lens 101 is changed by moving the magnification varying lens 102, and magnification variation (zooming) is performed. The magnification varying lens 102 may be drivable by an actuator. The focus lens 104 moves in the optical axis direction during focusing.

The lens control unit 105 as a lens control apparatus is a computer including a CPU, and is electrically connected to a memory 106, a zoom position detector 107, an aperture drive unit 108, and a focus drive unit 109. The lens control unit 105 receives a focus drive command including a drive amount of the focus lens 104 (referred to as a focus drive amount hereinafter) through communication with the camera control unit 207, and controls the focus drive unit 109 based on the focus drive command. Thereby, the focus lens 104 is driven. The lens control unit 105 also receives an aperture drive command from the camera control unit 207, and drives the aperture stop 103 by controlling the aperture drive unit 108 based on the aperture drive command. The lens control unit 105 receives a notification of an imaging start from the camera control unit 207.

The zoom position detector 107 detects the position of the magnification varying lens 102 (referred to as the zoom position hereinafter) using a zoom position sensor such as a variable resistor, and outputs information on the zoom position to the lens control unit 105. In this case, the lens control unit 105 may acquire information on the zoom position, such as information that can be converted to the zoom position, rather than information directly indicating the zoom position.

Information on the zoom position includes information on a rotation operation position of the zoom operation ring and information converted from the zoom position to the focal length.

The aperture drive unit 108 includes an aperture actuator such as a stepping motor or a voice coil motor that drives the aperture stop 103, and an aperture sensor such as a Hall element for detecting the drive position (aperture diameter) of the aperture stop 103. The focus drive unit 109 includes a focus actuator such as a stepping motor, a vibration type motor, or a voice coil motor, and a focus position sensor such as an encoder for detecting the position of the focus lens 104 in the optical axis direction (referred to as the focus position hereinafter).

The memory 106 includes a ROM, a RAM, etc., and stores electronic cam information as control information on the position of the focus lens 104 that is in focus on each object distance for each zoom position (referred to as an in-focus position hereinafter). In the following description, the electronic cam information is described as information on a curve indicating a locus (drive locus) along which the focus lens 104 moves, but in reality, it is table data indicating the in-focus position for each zoom position and object distance, or information on a function that is used to calculate the in-focus position.

The zoom lens 101 according to this embodiment is an inner focus (rear focus) type zoom lens, and the position of the image plane changes with zooming, and a focus position shifts. Thus, the lens control unit 105 performs zoom tracking that controls driving of the focus lens 104 using the electronic cam information stored in the memory 106 in order to reduce (compensate for) fluctuations of the image plane position during zooming, i.e., focus fluctuations.

The camera body 200 includes an image sensor 201, a signal processing unit 202, a recording processing unit 203, an electronic viewfinder 204, a display unit 205, a defocus detector 206, a camera control unit 207, and a memory 208.

The image sensor 201 includes a photoelectric conversion element such as a CCD sensor or a CMOS sensor, converts an object image into an imaging signal as an electrical signal (i.e., captures an object image), and outputs the imaging signal to the signal processing unit 202. In this embodiment, the image sensor 201 has imaging pixels that output imaging signals for generating a captured image, and a pair of focus detecting pixels that include a microlens for pupil division and a pair of photoelectric conversion elements, and output a focus detecting signal for AF.

The signal processing unit 202 performs various processing such as amplification, noise removal, and color correction for the input imaging signal to generate an image signal (image data), and outputs it to the recording processing unit 203.

The recording processing unit 203 records the input image data. The recorded image data is also displayed on the electronic viewfinder 204 and the display unit 205.

The defocus detector 206 detects a focus state of the zoom lens 101 for the object image using the pair of focus detecting signals from the image sensor 201. More specifically, the defocus detector 206 detects a phase difference (image shift amount) between the pair of focus detecting signals, calculates the defocus amount from the phase difference, and outputs it to the camera control unit 207.

The camera control unit 207 is a computer including a CPU, and is electrically connected to the recording processing unit 203, the defocus detector 206, and the memory 208. The camera control unit 207 reads and executes programs recorded in the memory 208, and communicates information for AF with the lens control unit 105. The information for AF includes information on an object distance obtained by converting a defocus amount using an equation coefficient obtained from an imaging relationship of the zoom lens 101 (referred to as object distance information hereinafter). The object distance information may be information indicating the object distance itself, or may be information that can be converted into object distance, such as a focus drive amount for obtaining an in-focus state calculated from the defocus amount and the focus position detected by a focus position sensor and received from the lens control unit 105.

In this embodiment, an image-plane phase-difference detecting method AF is performed, but a contrast detecting method AF may also be performed.

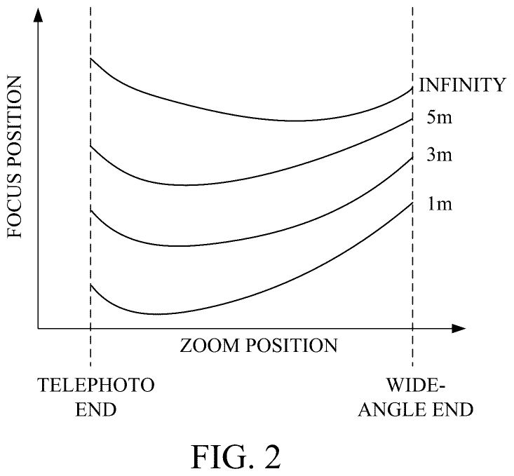

FIG. 2 illustrates electronic cam information, that is, information illustrating a relationship between a zoom position and a focus position (in-focus position) for obtaining an in-focus state according to an object distance. In FIG. 2, a horizontal axis illustrates the zoom position, and a vertical axis illustrates the focus position. A solid curve illustrates a relationship between the zoom position and the focus position for each object distance (1 m, 3 m, 5 m, and infinity). The memory 106 stores as the electronic cam information the focus position for each zoom position (which may be a representative zoom position) on the curve corresponding to each of a plurality of representative object distances.

In a case where the object distance accords with the representative object distance in the electronic cam information, the focus position can be obtained from the electronic cam information corresponding to the representative object distance. The lens control unit 105 sets the focus position as the focus target position, and controls driving of the focus lens 104 to the focus target position.

On the other hand, if the object distance is different from the representative object distance, the focus position can be obtained by a calculation such as linear interpolation using the electronic cam information corresponding to representative object distances near the object distance.

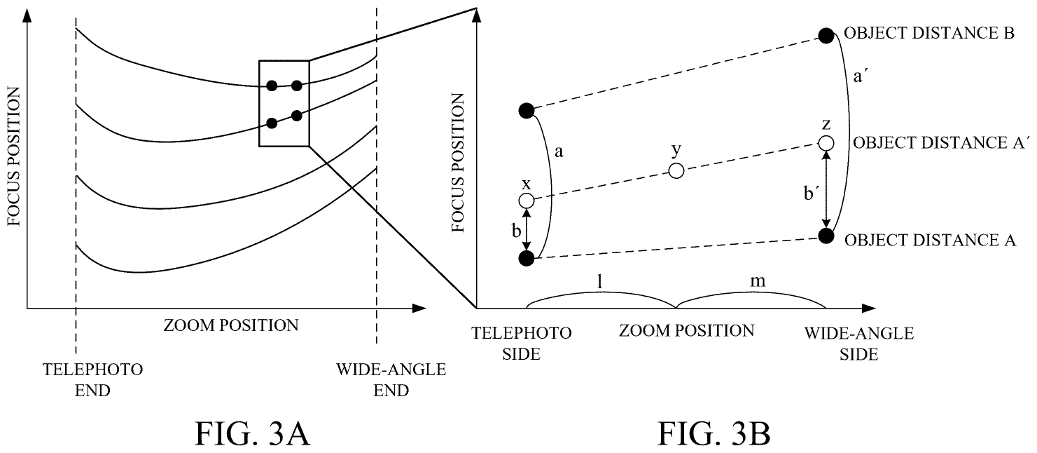

FIGS. 3A and 3B illustrate a method of calculating the focus position in a case where the object distance is different from the representative object distance. In FIGS. 3A and 3B, a horizontal axis indicates the zoom position, and the vertical axis indicates the focus position. FIG. 3A illustrates the entire electronic cam information, and FIG. 3B illustrates an enlarged view of a frame portion in FIG. 3A.

A description will now be given of the calculation of a focus position at a zoom position y between a wide-angle zoom position x and a telephoto zoom position z at an object distance A′ between representative object distances A and B. First, the lens control unit 105 reads out the focus positions at object distances A and B at wide-angle zoom position x from the electronic cam information, and calculates a ratio b/a between a difference a between them and a difference b between the focus positions at object distances A and A′. Then, using the focus positions at the object distances A and B and the ratio b/a, the lens control unit 105 calculates the focus position at the object distance A′ at the wide-angle zoom position x.

Next, the lens control unit 105 reads out focus positions at the object distances A and B at telephoto zoom position z from the electronic cam information. A ratio b′/a′ between a difference a′ between them and a difference b′ between the focus positions at object distances A and A′ is the same as the ratio b/a. Then, using the focus positions at the object distances A and B and the ratio b′/a′(=b/a), the focus position at object distance A′ at telephoto zoom position z is calculated.

Finally, the lens control unit 105 calculates a zoom moving amount 1, which is a difference between the wide-angle zoom position x and zoom position y, and a zoom moving amount m, which is a difference between the zoom position y and the telephoto zoom position z. Then, using a ratio 1/(1+m), of the focus positions and moving amounts at the wide-angle and telephoto zoom positions x and z at the object distance A′, a focus position at the zoom position y at the object distance A′ is calculated. The lens control unit 105 sets the focus position at zoom position y at the object distance A′ calculated in this way to a focus target position, and controls driving of the focus lens 104 to the focus target position.

A description will now be given of the lens control processing in a case where the focus lens 104 is driven by AF during zoom tracking according to this embodiment.

FIG. 12 illustrates a drive locus of a focus lens (referred to as the focus drive locus hereinafter) in a case where zooming is performed during continuous still image capturing (continuous shooting) in prior art and the focus lens is driven by AF during zoom tracking. A dashed line illustrates a focus drive locus for each object distance based on the electronic cam information. A part of a solid line labelled with an arrow ZT illustrates a drive locus of the focus lens due to the zoom tracking. The part of the solid line labelled with an arrow AF illustrates a drive locus of the focus lens due to the change in object distance acquired by AF. I1, I2, and I3 illustrate the imaging times during continuous shooting, and a black dot illustrates a focus target position at each imaging time.

As illustrated, while the focus lens is driven by the zoom tracking, the focus lens is driven by AF at times I1, I2, and I3. In FIG. 12, a drive direction of the focus lens by AF performed at time I1 is opposite to a drive direction of the focus lens by the zoom tracking before and after time I1. In other words, reverse drive of the focus lens occurs. As described above, the reverse drive of the focus lens is likely to increase the control deviation in the control of driving of the focus lens, so the reverse drive of the focus lens may be avoided even if the object distance acquired by AF changes.

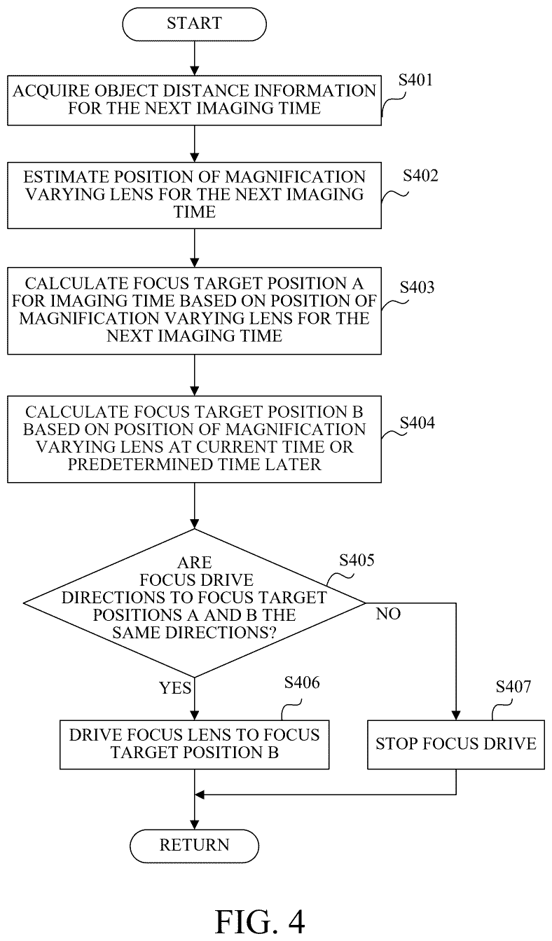

A flowchart in FIG. 4 illustrates lens control processing (lens control method) that can avoid the reverse drive of the focus lens 104 due to AF (change in object distance) during zoom tracking. The lens control unit 105 executes this processing according to a computer program. In the following description, driving of the focus lens 104 will be referred to as focus drive, and a direction in which the focus lens 104 is driven will be referred to as a focus drive direction. The time of each imaging in continuous shooting will be referred to as the imaging time.

First, the lens control unit 105 as an acquiring unit acquires object distance information at the next imaging time (second time) determined by AF from the camera control unit 207 in step S401 at the current time (first time). The lens control unit 105 may receive a notification of the next imaging time from the camera control unit 207, may estimate the next imaging time from the interval between previous imaging times, or may estimate the next imaging time from a focus drive command for AF.

Object distance information for the next imaging time is determined and updated by AF, and is updated using object distance information communicated from the camera control unit 207 to the lens control unit 105 regardless of the timing of step S401. Object distance information for the next imaging time may be estimated and acquired from the current object distance and the past object distance.

Next, in step S402, the lens control unit 105 estimates (acquires) the zoom position for the next imaging time. The zoom position for the next imaging time can be estimated from the current zoom position and the past position.

Next, in step S403, the lens control unit 105 calculates and acquires a focus target position A (first target position) for the next imaging time based on the estimated zoom position for the next imaging time, object distance information, and electronic cam information stored in memory 106.

Next, in step S404, the lens control unit 105 calculates and acquires a focus target position B (second target position) at the current time or a predetermined time later based on the position of the magnification varying lens 102 at the current time or a predetermined time after the current time (both are the first time), object distance information at the next imaging time, and locus information stored in memory 106.

Next, in step S405, the lens control unit 105 as a control unit determines whether or not the focus drive direction to the focus target position A and the focus drive direction to the focus target position B are the same directions. In a case where they are the same, the flow proceeds to step S406, and in a case where they are opposite, the flow proceeds to step S407.

In step S406, the lens control unit 105 causes the focus drive unit 109 to perform focus drive to the focus target position B. Then, the processing from step S401 is repeated during zooming.

In step S407, the lens control unit 105 causes the focus drive unit 109 to stop focus drive. The flow from step S401 is repeated during zooming.

The flow illustrated in FIG. 4 is repeatedly executed at a predetermined control period. During non-imaging, focus drive to the focus target position B is always performed. The control period may be constant or may vary according to a processing state. As the current time approaches the next imaging time, the estimation accuracy of the zoom position can be improved, and the calculation accuracy of the focus target position (first target position) can be improved. Therefore, by periodically repeating the flow in FIG. 4, a more accurate focus target position is updated while focus drive to the focus target position is performed.

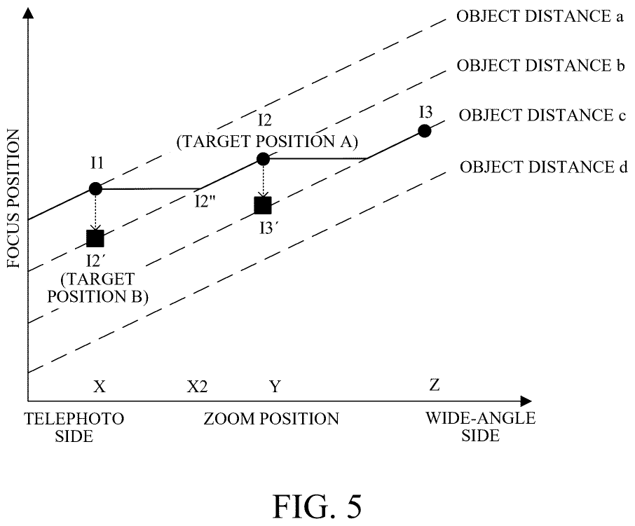

FIG. 5 illustrates the focus drive locus by the lens control processing in FIG. 4 using a solid line. I1, I2, and I3 indicate imaging times during continuous shooting, as in FIG. 12. I2 is the next imaging time relative to I1, and I3 is the next imaging time relative to I2. The zoom positions at I1, I2, and I3 are illustrated as X, Y, and Z, respectively. A dashed line indicates a focus drive locus for each of the object distances (a to d) based on electronic cam information, and each focus drive locus will be referred to as the same distance locus hereinafter. A black dot indicates the focus target position A for the next imaging time calculated in step S403 of FIG. 4. The focus target position A for the next imaging time is updated according to the object distance information obtained by AF, and is the focus position at I2 in a case where the zoom position is between X and Y, and is the focus position at I3 in a case where the zoom position is between Y and Z.

A black square indicates the focus target positions B corresponding to the zoom positions at I2′ and I3′ as the current times calculated in step S404. I2′ and I3′ may be the same times as the imaging times I1 and I2, respectively, or may be a predetermined time after I1 and I2 (after AF is performed). The zoom position at I2′ is X, and the zoom position at I3′ is Y. The zoom position at which focus drive starts after the focus drive stops between the zoom positions X and Y is X2.

As illustrated, the focus drive direction to the focus target position B at I2′ and the focus drive direction to the focus target position A at the next imaging time I2 are opposite to each other. At this time, focus drive is stopped in step S407 in FIG. 4. While the zoom position is between X and X2, step S407 is executed for each focus drive control period, and focus drive continues to be stopped.

In a case where the zoom position reaches X2 at I2″ near the next imaging time I2, the focus drive direction to the focus target position B and the focus drive direction to the focus target position A calculated at this time (current time) become the same directions. Thus, while the zoom position is between X2 and Y, focus drive to the focus target position B is performed in step S406 in FIG. 4. Since focus drive control is periodically performed, the focus lens 104 moves to follow the same distance locus at the object distance b. As a result, the focus lens 104 reaches the focus target position A at the next imaging time I2. Similar focus drive is also performed while the zoom position is between Y and Z.

Thus, this embodiment stops focus drive in a case where the direction of the focus target position relative to the zoom position for a time prior to the next imaging time and the direction of the focus target position relative to an estimated zoom position for the next imaging time are opposite to each other. Then, focus drive is started in a case where these directions become the same. Thereby, reverse drive of the focus lens 104 can be avoided and the control deviation can be reduced even if AF is performed during zoom tracking (even if the object distance changes), and the in-focus accuracy can be improved at each imaging time.

### Second Embodiment

A description of a second embodiment will now be given. The second embodiment performs focus drive at a speed that enables the focus lens 104 to reach the focus target position for the next imaging time, prior to the next imaging time. Those elements in this embodiment, which are common elements to those of the first embodiment, will be designated by the same reference numerals.

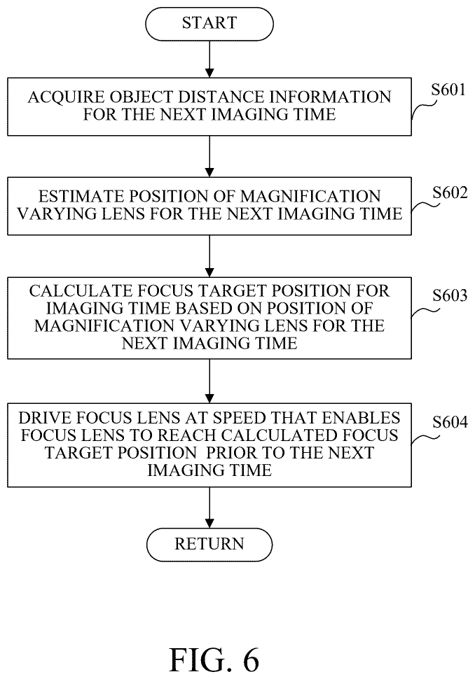

A flowchart in FIG. 6 illustrates lens control processing according to this embodiment. First, in step S601 at the current time (first time), the lens control unit 105 acquires object distance information for the next imaging time determined by AF from the camera control unit 207, similarly to step S401 in FIG. 4.

Next, in step S602, the lens control unit 105 estimates the zoom position at the next imaging time (second time), similarly to step S402.

Next, in step S603, the lens control unit 105 calculates the focus target position (first target position) for the next imaging time based on the estimated zoom position for the next imaging time, the object distance information for the next imaging time, and the electronic cam information, similarly to step S403.

Next, in step S604, the lens control unit 105 causes the focus drive unit 109 to perform focus drive at a speed that enables the focus lens 104 to reach the focus target position calculated in step S603 before the next imaging time comes. The speed at this time may be a predetermined speed (such as a maximum drivable speed of the focus lens 104) or may be a speed calculated so that the focus lens 104 reaches the focus target position before the next imaging time comes. Then, this flow ends.

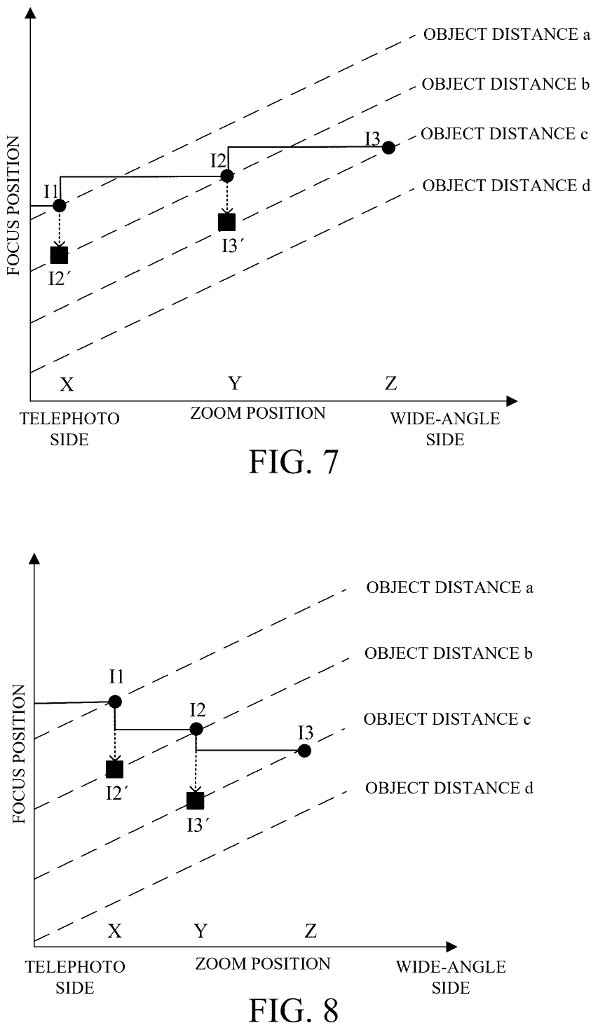

FIG. 7 illustrates a focus drive locus in this embodiment with a solid line. Dashed lines, I1, I2, I3, I2′, I3′, and zoom positions X, Y, and Z are the same as those in FIG. 5.

As illustrated, the focus drive direction to the focus target position (black square) at I2′ and the focus drive direction to the focus target position (black dot) at the next imaging time I2 are opposite to each other. In this case, in this embodiment, focus drive to the focus target position at I2′ is not performed, and focus drive is performed from the time at the zoom position X to the next imaging time I2 at the focus target position. After focus drive is performed to the focus target position at the next imaging time I2, focus drive is stopped until the next imaging time I2 when the zoom position reaches Y. However, instead of stopping focus drive, focus drive may be performed according to updating the focus target position according to updating the estimated zoom position.

Focus drive from the imaging time I2 to the next imaging time I3 is similar to the focus drive from I1 to I2 described above.

FIG. 8 illustrates a focus drive locus using a solid line in a case where the focus drive direction to the focus target position at I2′ (I3′) and the focus drive direction to the focus target position at the next imaging time I2 (I3) are the same directions. Even in this case, reverse drive occurs if a drive amount of focus drive to the focus target position at I2′ is larger than a drive amount of focus drive to the focus target position at the next imaging time I2. However, in this embodiment, reverse drive is not performed by performing focus drive to the focus target position at I2 so that the focus lens 104 does not reach (or does not move toward) the focus target position at I2′ beyond the focus target position at I2.

The first embodiment performs focus drive to the focus target position at I2′ without stopping the focus drive, in a case where the focus drive direction to the focus target position at I2′ and the focus drive direction to the focus target position at the next imaging time I2 are the same directions. Therefore, reverse drive cannot be avoided. On the other hand, this embodiment can avoid reverse drive even in a case such as that illustrated in FIG. 8.

Both FIGS. 7 and 8 illustrate examples of focus drive in which reversal drive can occur, but even if reversal drive does not occur, the control deviation can be reduced by driving the focus lens 104 to the focus target position for the next imaging time as in this embodiment.

Thus, this embodiment performs focus drive so that the focus lens 104 reaches the focus target position for the next imaging time, prior to the next imaging time without performing reverse drive. Thereby, reverse drive of the focus lens 104 can be avoided and the control deviation can be reduced even if AF is performed during zoom tracking, and the in-focus accuracy at each imaging time can be improved. Furthermore, the second embodiment can avoid reverse drive of a pattern that cannot be avoided by the lens control processing according to the first embodiment.

The first embodiment has a meritorious effect that the control deviation can be reduced because the acceleration and deceleration are small, and the second embodiment has a meritorious effect that reverse drive can be avoided. Therefore, in a situation where reverse drive can be avoided even in the first embodiment, focus drive may be performed by the method according to the first embodiment, and in a situation where reverse drive can be avoided only in the second embodiment, focus drive may be performed by the method according to the second embodiment.

### Third Embodiment

A description of a third embodiment will now be given. The third embodiment performs focus drive at a speed that enables the focus lens 104 to reach the focus target position for the next imaging time, at the next imaging time. Those elements in this embodiment, which are corresponding elements in the first embodiment, will be designated by the same reference numerals.

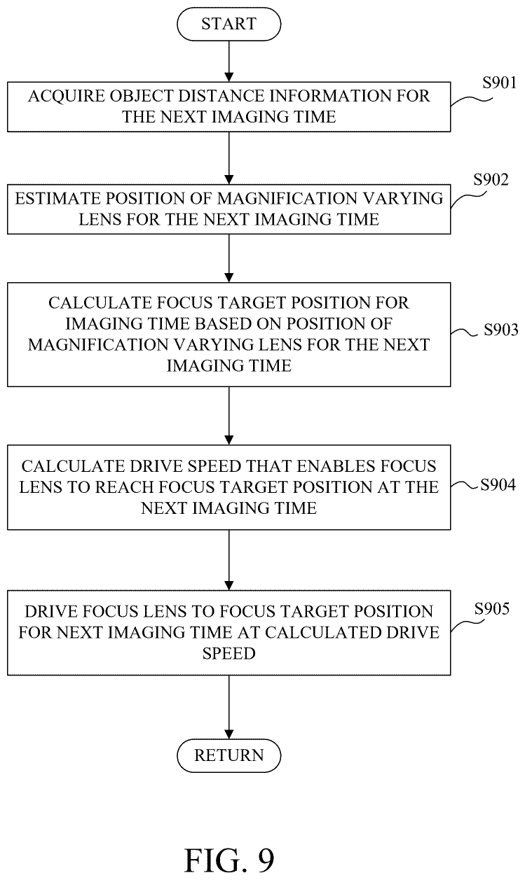

A flowchart in FIG. 9 illustrates lens control processing according to this embodiment. First, in step S901 at the current time (first time), the lens control unit 105 acquires object distance information for the next imaging time determined by AF from the camera control unit 207, similarly to step S401 in FIG. 4.

Next, in step S902, the lens control unit 105 estimates the zoom position for the next imaging time (second time), similarly to step S402.

Next, in step S903, the lens control unit 105 calculates the focus target position for the next imaging time (first target position) based on the estimated zoom position for the next imaging time, the object distance information for the next imaging time, and the electronic cam information, similarly to step S403.

Next, in step S904, the lens control unit 105 calculates the drive speed of the focus lens 104 at which the focus lens 104 will reach the focus target position at the next imaging time calculated in step S903.

Next, in step S905, the lens control unit 105 causes the focus drive unit 109 to perform focus drive to the focus target position for the next imaging time calculated in step S903 at the drive speed calculated in step S904.

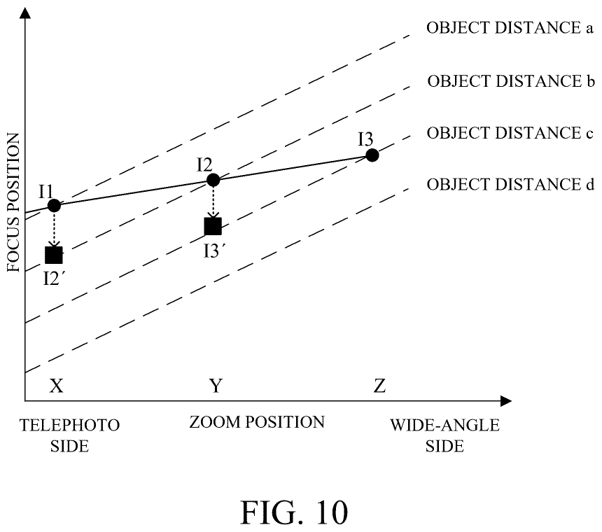

FIG. 10 illustrates a focus drive locus in this embodiment with a solid line. Dashed lines, I1, I2, I3, I2′, I3′, and zoom positions X, Y, and Z are similar to those in FIG. 5.

As illustrated, the focus drive direction to the focus target position at I2′ (black square) and the focus drive direction to the focus target position at the next imaging time I2 (black dot) are opposite to each other. The lens control processing in FIG. 9 does not perform focus drive to the focus target position at I2′, but performs focus drive to the focus target position at the next imaging time I2 from the beginning at the drive speed calculated in step S904.

Focus drive from imaging time I2 to the next imaging time I3 is similar to the focus drive from I1 to I2 described above.

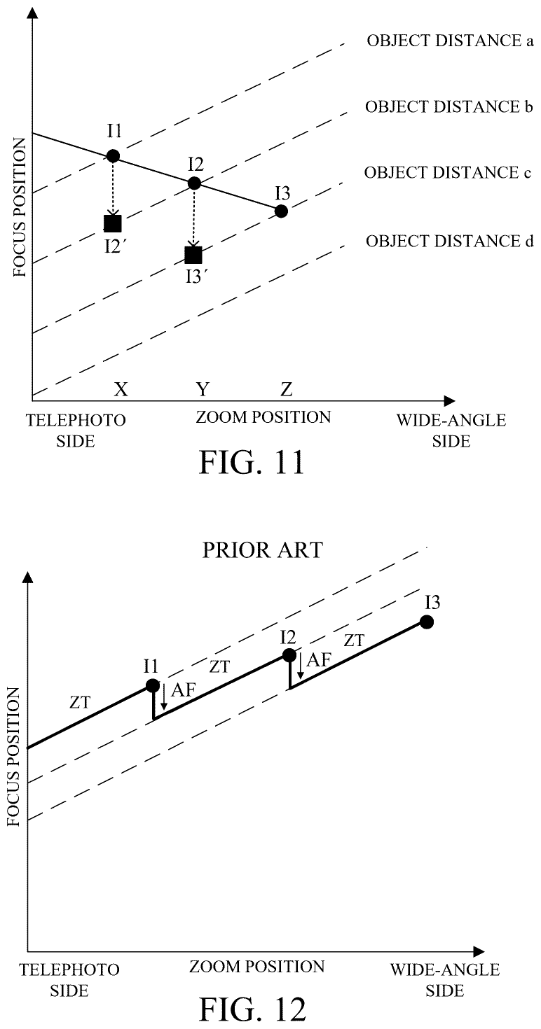

FIG. 11 illustrates a focus drive locus to the focus target position with a solid line in a case where the focus drive direction to the focus target position at I2′ (I3′) and the focus drive direction to the focus target position at the next imaging time I2 (I3) are the same directions. Even in this case, reverse drive occurs if a drive amount of the focus drive to the focus target position at I2′ is larger than a drive amount of the focus drive to the focus target position at the next imaging time I2. However, as in the second embodiment, even this embodiment does not perform reverse drive by performing focus drive to the focus target position at I2 so that the focus lens 104 does not reach the focus target position at I2′ beyond the focus target position at I2. Moreover, since focus drive is not suddenly accelerated, decelerated, or stopped, the control deviation of the focus drive can be reduced more effectively than that in the second embodiment.

Both FIGS. 10 and 11 illustrate examples of focus drive in which reverse drive can occur, but even if reverse drive does not occur, the control deviation can be reduced by performing focus drive to the focus target position for the next imaging time as in this embodiment.

Thus, this embodiment does not perform reverse drive but performs focus drive at a speed that enables the focus lens 104 to reach the focus target position for the next imaging time, at the next imaging time. Thereby, even if AF is performed during zoom tracking, reverse drive of the focus lens 104 can be avoided, the control deviation can be reduced, and improve the in-focus accuracy at each imaging time can be improved.

The first to third embodiments perform focus drive to a focus target position for the next imaging time as the second time, but may perform the focus drive according to each embodiment even in a case where focus drive is performed to the focus target position for a second time other than the next imaging time. The second time other than the next imaging time may be, for example, a time based on the time at which object distance information is obtained by AF (such as a predetermined time after that time). Thereby, focus drive similar to that of each embodiment can be performed even during non-imaging.

In a case where the second time is the next imaging time, as described in step S401 of FIG. 4, a specific time may be estimated based on a signal that notifies the imaging time transmitted from the camera control unit 207, or the next imaging time may be communicated from the camera control unit 207. In a case where AF for the next imaging is performed just after the current imaging is completed, it is ideal that the current imaging time and the AF time for obtaining an in-focus state at the next imaging time approximately coincide with each other. In a case where the current imaging time and the AF time for the next imaging approximately coincide with each other, the next imaging time as the second time can also be estimated based on the AF period.

The second time is updated every second time. AF may be performed at a time other than the second time, as long as object distance information at that time can be obtained.

Lens control processing may be performed by combining the lens control processing according to at least two of the first to third embodiments.

In the first to third embodiments, the lens control apparatus is mounted on a lens apparatus that is attachable to and detachable from the image pickup apparatus, but the lens control apparatus may be mounted on the image pickup apparatus to which the lens apparatus is detachably attached, or the lens control apparatus may be mounted on a lens integrated type image pickup apparatus.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions.

The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can provide good in-focus accuracy even if AF is performed during zoom tracking.

This application claims priority to Japanese Patent Application No. 2023-208376, which was filed on Dec. 11, 2023, and which is hereby incorporated by reference its entirety.

What is claimed is:

1. A control apparatus for reducing focus fluctuation of a zoom lens including a focus lens and a magnification varying lens, the control apparatus comprising:
a processor configured to:
acquire, at a first time, information on a position of the magnification varying lens for a second time after the first time and information on an object distance for the second time,
acquire a first target position according to the position of the magnification varying lens at the second time and the object distance at the second time, using control information on the position of a magnification varying lens and a position of the focus lens according to the object distance, and
control driving of the focus lens using control information and the first target position.

2. The control apparatus according to claim 1, wherein the processor is configured to control the driving of the focus lens using the first target position so that a drive direction of the focus lens is not reversed in a case where the object distance acquired from the information on the object distance changes from the first time to the second time.

3. The control apparatus according to claim 1, wherein the processor is configured to:
acquire a second target position according to the position of the magnification varying lens at a time between the first time and a time prior to the second time, and the object distance at the second time, using the control information,
stop driving the focus lens in a case where a drive direction of the focus lens to the first target position and a drive direction of the focus lens to the second target position are opposite to each other, and
start driving the focus lens in a case where the drive direction to the first target position and the drive direction to the second target position become the same directions.

4. The control apparatus according to claim 1, wherein the processor is configured to:
acquire a second target position according to the position of the magnification varying lens at a time between the first time and a time prior to the second time, and the object distance at the second time, using the control information, and
control the driving of the focus lens so that the focus lens does not reach the second target position beyond the first target position in a case where a drive direction of the focus lens to the first target position and a drive direction of the focus lens to the second target position are the same directions and a drive amount of the focus lens to the second target position is larger than a drive amount of the focus lens to the first target position.

5. The control apparatus according to claim 1, wherein the processor is configured to control the driving of the focus lens so that the focus lens reaches the first target position at a time prior to the second time.

6. The control apparatus according to claim 1, wherein the processor is configured to control the driving of the focus lens so that the focus lens reaches the first target position at the second time.

7. The control apparatus according to claim 1, wherein the second time is a time at which imaging is performed.

8. The control apparatus according to claim 1, wherein the second time is a time based on a time at which the information on the object distance is acquired.

9. A lens apparatus comprising:
an imaging optical system including a magnification varying lens and a focus lens; and
the control apparatus according to claim 1.

10. The lens apparatus according to claim 9, wherein the lens apparatus is attachable to and detachable from an image pickup apparatus configured to image an object through the imaging optical system, and
wherein the processor is configured to acquire the information on the object distance from the image pickup apparatus.

11. An image pickup apparatus comprising:
an image sensor configured to image an object through an imaging optical system including a magnification varying lens and a focus lens; and
the control apparatus according to claim 1.

12. A control method for reducing focus fluctuation of a zoom lens including a focus lens and a magnification varying lens, the control method comprising the steps of:
acquiring, at a first time, information on a position of the magnification varying lens for a second time after the first time and information on an object distance for the second time,
acquiring a first target position according to the position of the magnification varying lens at the second time and the object distance at the second time, using control information on the position of a magnification varying lens and a position of the focus lens according to the object distance; and
controlling driving of the focus lens using control information and the first target position.

13. A non-transitory computer-readable storage medium storing a program that causes a computer to execute the control method according to claim 12.
